(19) United States
(12) Patent Application Publication
(10) Pub. No.: US 2005/0269788 A1
(43) Pub. Date: Dec. 8, 2005

(54) Gasket assembly and method

(76) Inventor: Aron A. Grunfeld, Northbrook, IL (US)

Correspondence Address: PAUL J. NYKAZA, ESQ.;WALLENSTEIN WAGNER & ROCKEY, LTD., 53RD FLOOR, 311 SOUTH WACKER DRIVE, CHICAGO, IL, 60606-6630, US

(21) Appl. No.: 10/859,460

(22) Filed: Jun. 2, 2004

(51) Int. Cl. F02F 11/00; F16J 15/02

(52) U.S. Cl. 277/592; 277/628

(57) ABSTRACT

A gasket assembly (10) for use with a first engine component having a first coolant passageway and a second engine component having a second coolant passageway is provided. The gasket assembly (10) comprises a plastic base (12) adapted to be disposed between the first engine component and the second engine component The plastic base (12) defines an opening (20) adapted to align with the first coolant passageway and the second coolant passageway when the base (12) is disposed between the first engine component and the second engine component. The gasket assembly (10) also includes a protector (14) associated with the coolant opening (20) of the base (12) and adapted to protect the base (12) from a coolant flowing through the first coolant passageway and the second passageway wherein the coolant is adapted to contact the protector (14) and not the base (12).

### TECHNICAL FIELD

The present invention relates to gasket assemblies. More specifically, the present invention relates to a gasket assembly including a plastic carrier and a metal insert.

### BACKGROUND OF THE INVENTION

Gaskets for providing a seal between mating parts of various devices are well known, as are gaskets for use in an automotive environment. One typical gasket comprises a plastic base having one or more openings. The opening is adapted to mate with, for instance, a coolant passageway of an engine assembly. Surrounding the opening and extending slightly from the gasket is usually a bead of an elastomeric material. When the gasket is sandwiched between an engine block and head, for example, the bead provides a fluid tight seal between the block, gasket and head. Such gaskets are also used in a wide variety of other applications.

However, it has been discovered that certain types of coolants and/or other fluids currently being used in engine assemblies can react with and degrade the plastic material used to form the gasket bases. It is known in the art to produce a gasket completely from aluminum or other suitable metal. The metal material does not react with and is not degraded by such coolants. Such a solution, however, is typically only used regularly on expensive race cars and perhaps other expensive vehicles due to the high cost involved in manufacturing such a gasket.

While gaskets according to the prior art provide a number of advantageous features, they nevertheless have certain limitations including those discussed above. The present invention seeks to overcome certain of these limitations and other drawbacks of the prior art, and to provide new features not heretofore available.

### SUMMARY OF THE INVENTION

The present invention provides a gasket assembly to be generally disposed between mating components. According to one aspect of the invention, the gasket assembly has a plastic base, or carrier, and a metal insert carried by the plastic base. The metal insert defines an opening spaced away from the base. The opening is adapted to receive a flowable substance to pass therethrough.

According to another aspect of the invention, an elastomer member is positioned about a perimeter of the opening. The elastomer member may have a flanged-T-shaped cross section having a flanged T-shape.

According to another aspect of the invention, a spacer is carried by the plastic base. In one preferred embodiment, the spacer and the metal insert are formed from a unitary piece of metal. The spacer is adapted to receive a fastener.

According to another aspect of the invention, a second metal insert is carried by the plastic base wherein the second metal insert defines a second opening. In a preferred embodiment, the second metal insert is a mirror image of the metal insert.

According to another aspect of the invention, the gasket assembly has a pathway having a first segment defined by the plastic base and a second segment defined by the metal insert. In one preferred embodiment, a portion of the second segment may also be deferred by the plastic carrier in cooperation with the metal insert. The pathway receives a bead of elastomeric material adapted to seal the first passageway to the second passageway. In a preferred embodiment, the first segment is contiguous with the second segment.

According to another aspect of the invention, the metal insert has an outer edge embedded within the plastic base. The edge defines a protrusion embedded within the plastic base. The edge may define a lip embedded within the plastic base.

According to another aspect of the invention, the metal insert has a first side and a second side. An elastomer member is positioned around the opening on the first side and the second side. According to another aspect of the invention, the metal insert has a first passageway on the first side and a second passageway on the second side. The elastomer member is received in the first passageway and the second passageway.

According to another aspect of the invention, the gasket assembly may be used with a first engine component having a first passageway and a second engine component having a second passageway. The gasket assembly has a plastic base adapted to be disposed between the first engine component and the second engine component and defining an opening adapted to align with the first and second passageways when the base is disposed between the first and second engine components. The gasket assembly further has a protector in communication with the opening of the base and adapted to protect the base from a fluid flowing through the first passageway and the second passageway. In one preferred embodiment, the protector is in the form of a metal insert wherein the metal insert completely defines the opening for the fluid to pass therethrough.

According to yet another aspect of the invention, a method of manufacturing a gasket assembly is provided. A metal insert defining a fluid opening and having an edge is placed into a first injection mold. Plastic material is injected into the first injection mold such that a plastic carrier is formed about the metal insert wherein the edge of the metal insert is embedded within the plastic carrier. The plastic carrier is removed from the first injection mold and is placed into a second injection mold. An elastomeric material is injected into the second injection mold such that a bead of the elastomeric material is placed about a periphery of the fluid opening.

Other features and advantages of the invention will become apparent from the following description taken in conjunction with the following drawings.

### BRIEF DESCRIPTION OF THE DRAWINGS

The gasket assembly of the invention will now be described with reference to the accompanying drawings, in which:

FIG. 1 is a plan view of a gasket according to a preferred embodiment of the present invention;

FIG. 2 is a partial cross-sectional view of the gasket of FIG. 1 taken along the lines 2-2 of FIG. 1;

FIG. 3 is a perspective view of a gasket according to an additional preferred embodiment of the present invention;

FIG. 4 is a partial exploded schematic view showing the gasket of FIG. 3 positioned within an engine assembly;

FIG. 5 is a plan view of the gasket of FIG. 3;

FIG. 6 is a side elevation view of the gasket of FIG. 3;

FIG. 7 is a cross-sectional view of the gasket of FIG. 3 taken along the lines 7-7 of FIG. 3;

FIG. 8 is a plan view of a metal insert of the gasket of FIG. 3;

FIG. 9 is a perspective view of the metal insert of FIG. 8;

FIG. 10 is partial schematic cross-sectional view of the gasket of FIG. 3 disposed between components of an engine assembly;

FIG. 11 is a partial schematic cross-sectional view of an injection mold utilized in the process of manufacturing the gasket of FIG. 3; and

FIG. 12 is a partial schematic cross-sectional view of an additional injection mold utilized in the process of manufacturing the gasket of FIG. 3.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

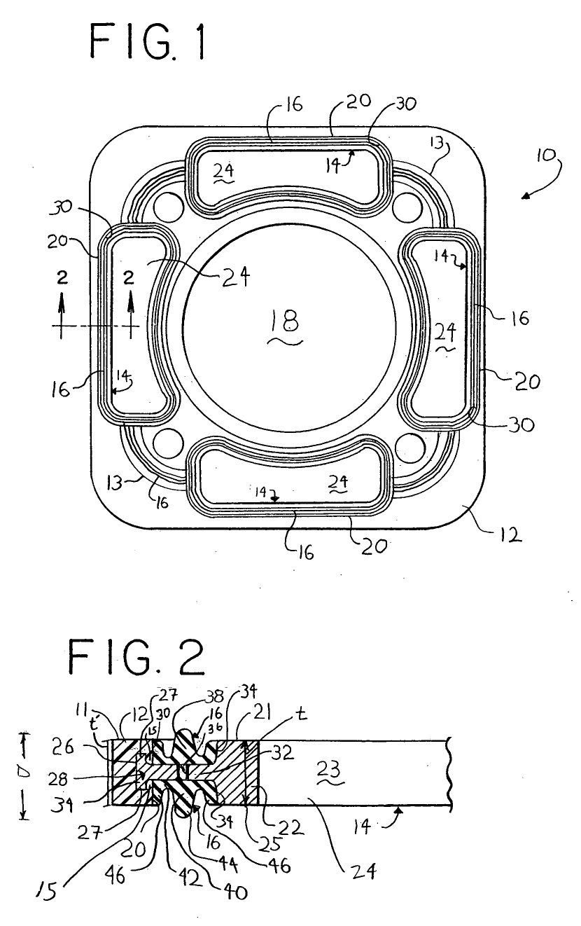

FIG. 1 shows a gasket or gasket assembly designated with the reference numeral 10. The gasket assembly 10 generally includes a base or carrier 12, an insert or protector 14 and a bead 16 of seal material.

As further shown in FIGS. 1 and 2, the base or carrier 12 is generally made from plastic and in a preferred embodiment, is injection-molded. This process will be described in greater detail below. The carrier 12 has a large central opening 18 or bore 18, and a plurality of smaller insert openings 20 surrounding the central bore 18. The carrier 12 also has a plurality of base pathways or plastic pathways 13 that will receive the bead 16 of material to be described in greater detail below. While the base 12 is preferably made from plastic, it is understood that the base 12 could be made from other materials. The openings 18,20 are designed to allow a flowable substance, such as a fluid, to pass therethrough. For example, the gasket 10 is generally designed to be positioned between mating components and provide a seal therebetween. In an automotive embodiment, the insert opening 20 may be adapted to align with coolant openings of the mating components and provide a seal therebetween. Coolant would pass through the insert 14 to be described below.

The insert or protector 14 is preferably made from metal. In a preferred embodiment, a plurality of metal inserts 14 are used with the gasket assembly 10. Each metal insert 14 has an interior wall 22 (See FIG. 2) having an interior face 23, an upper surface 21 and a lower surface 25. The interior face 23 further defines a fluid or insert opening 24 spaced away from the base 12. Each metal insert 14 also has an outer edge 26 located proximal to an outer perimeter 28 thereof. The outer edge 26 may also define one or more lips 27. Each metal insert 14 further has an insert pathway or metal pathway 30 formed by a lateral wall 32 and a pair of side walls 34. Located in the lateral wall 32 is a plurality of pathway holes 36. The metal pathway 30 communicates with the plastic pathway 13, and is contiguous and generally flush therewith. As further shown in FIG. 2, in one preferred embodiment, a portion 15 of the plastic base 12 may define part of the pathway 30 in cooperation with the metal insert 14. Thus, the pathway 30 itself may be considered to be of metal material and plastic material. Alternatively, the outer edge 26 could be dimensioned to completely define the metal pathway 30. It should be noted that although not shown in the FIGS., the plastic pathway 13 is similarly formed by a lateral wall having a plurality of pathway holes and a pair side walls. As shown in FIGS. 1 and 2, it is appreciated that the metal insert 14 completely defines the insert opening 24 of the gasket 10. The opening 24 is defined completely by the metal material of the insert 14 and not any plastic material of the base 12. Thus, any flowable material passing through the insert opening 24 contacts only metal of the insert 14 and not plastic material of the base 12. It is further understood that the base and insert have pathways on a first, or upper surface, and a second, or lower surface. The upper and lower pathways generally coincide.

A bead 16 of a seal material is used with the gasket 10. In a preferred embodiment, the bead 16 is in the form of an elastomer and is received by both the plastic pathway 13 and the metal pathway 30. The bead 16 is adapted to abut against the mating components and provide a seal. The bead 16 has an upper bead portion 38 and a lower bead portion 40 opposed to the upper bead portion 38. The use of the terms upper and lower have no significance other than to distinguish the two bead portions 38,40 as shown in FIG. 2. The upper bead portion 38 is connected to the lower bead portion 40 wherein a portion of the elastomer extends through each pathway hole 36. In embodiments wherein a portion of the pathway extends to a peripheral edge of the carrier 12, the upper bead portions 38 and the lower bead portions 40 connect to one another at the peripheral edge. It is further understood that the upper bead portion 38 is located on a first or upper surface of the base 12 and the lower bead portion 40 is located on a second or lower surface of the base 12.

Each bead portion 38,40 has a generally flanged-T-shape, or M-shaped, cross-section as seen in FIG. 2. The cross-section of each bead portion 38,40 is comprised of a bead base 42, a central bead leg 44 and a pair of outer bead legs 46. The central bead leg 44 and outer bead legs 46 each extend from the their respective bead base 42 in the same direction. However, the central bead leg 44 extends further than either of the outer bead legs 46. Additionally, it can be seen that a distance D, as shown in FIG. 2 and defined by the central bead leg 44 of the upper bead portion 38 and the central bead leg 44 of the lower bead portion 40, is greater than a thickness t of the interior wall 22 and is also greater than a thickness t′ of the carrier 12. Also, an end or extent 45 of the central bead leg 44 extends beyond a surface 11 of the base 12.

The gasket 10 is produced by a process of over-molding to be described in detail below. However, it can be seen primarily in FIG. 2 that a portion of the outer edge 26 of the insert 14 is embedded within the plastic carrier 12. The lip 27 defined by the edge 26 is also embedded within the plastic carrier 12. As discussed, it is understood that the outer edge 28 of the insert could be dimensioned larger such that the insert would form the outer wall defining the insert or metal pathway 30. It is understood that the gasket 10 can take many different shapes and forms. Additionally, the gasket 10 may be adapted to be placed between any two components to seal mating openings of the components.

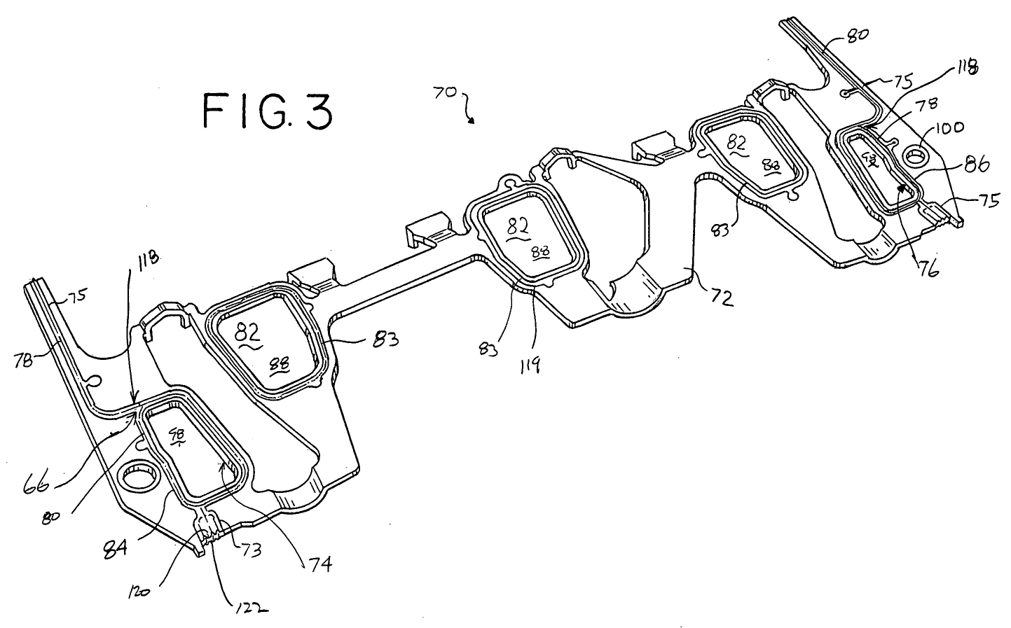

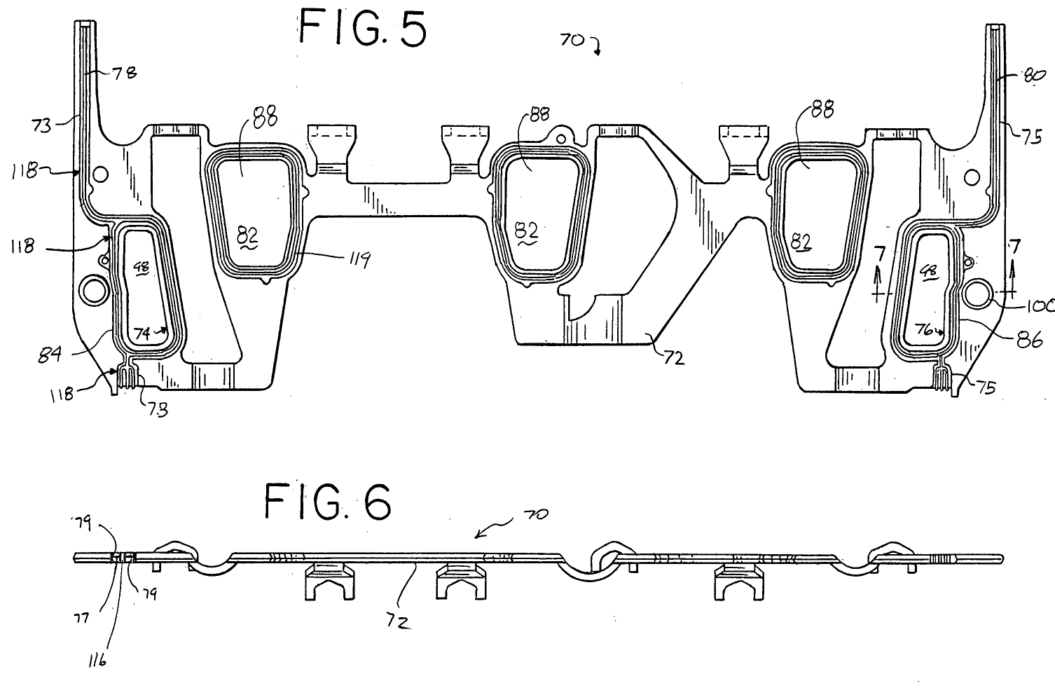

FIGS. 3-10 depict a gasket assembly 70 of an additional embodiment of the present invention. The gasket assembly 70 includes a plastic base or carrier 72, a first insert or protector 74, a second insert or protector 76, and an elastomer bead 66 including a first bead of the elastomer material 78 and a second bead of the elastomer material 80.

As further shown in FIGS. 3-7, the carrier 72 includes a plurality of carrier openings 82. In the embodiment shown, the carrier 72 includes five openings 82 comprising a first end opening 84, a second end opening 86 and three central openings 88. The carrier 72 also includes a first carrier or plastic pathway 73 located proximal the first end opening 84 and a second carrier or plastic pathway 75 located proximal the second end opening 86. As shown in FIG. 6, each carrier pathway 73,75 is formed by a lateral wall 77 having a plurality of pathway holes 116 and a pair of side walls 79. (It is understood that a portion of the elastomer bead 66 is removed to show the walls 77,79 forming the carrier pathway 73.) It is further understood that the carrier 72 includes pathways 73 around the peripheries of the central openings 88. It is also understood that the first carrier pathway 73 and the second carrier pathway 75 include pathways on a first or upper surface of the carrier 72 and a second or lower surface of the carrier 72. The pathways 73,75 on the upper and lower surfaces of the carrier 72 generally coincide and are mirror images of one another. The pathways 73,75, while generally located around the peripheries of the first end opening 84 and the second end opening 86, also have portions that extend to peripheral edges of the carrier 72. It is further understood that in the particular embodiments shown and described herein, the various pathways are shown having a particular shape in cross section. However, any shaped pathway may be utilized. Any of the various pathways may be flat and contiguous with the base 72 or insert 74 and further defined merely by a width and length of the elastomeric bead 66,78,80 deposited thereon. Thus, the bead 66,78,80 may be merely positioned on a surface of the carrier 72.

The first metal insert 74 and second metal insert 76 are mirror images of one another, therefore, only the first metal insert 74 will be discussed in detail. Also, the first bead 78 and second bead 80 are mirror images of one another. Likewise, only the first bead 78 will be discussed in detail. With this configuration of gasket assembly 70, only a single insert 74 need be manufactured. A second insert 76, identical to the first metal insert 74, is inverted to be used in connection with the second end opening 86.

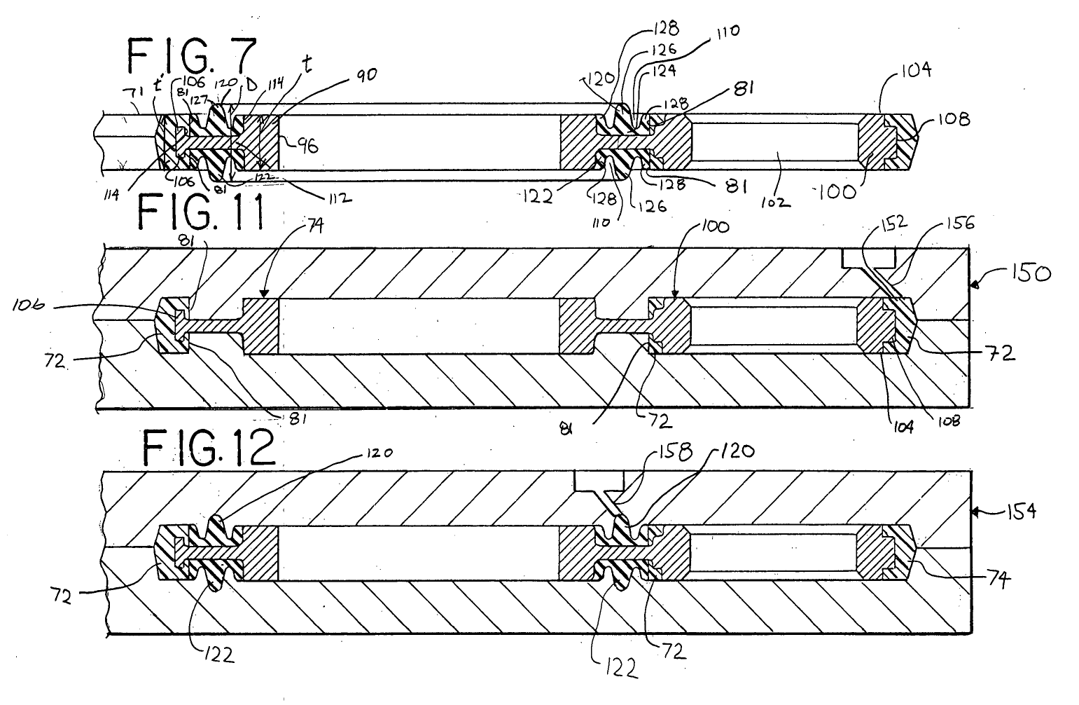

As further shown in FIGS. 8 and 9, the insert 74 is generally dimensioned to fit within the end openings 84,86 of the carrier 72. As described in greater detail below, in one preferred embodiment, the carrier 72 is formed around the insert 74. The insert 74 has an interior wall 90 having an upper surface 92, a lower surface 94 and an interior face 96 defining a fluid or inlet opening 98 spaced from the carrier 72. The insert 74 also has a spacer or limiter 100 formed therein defining a fastener aperture 102. In a preferred embodiment, the spacer 100 is integral with the overall body of the insert 74. Also, the insert 74 has a perimeter edge 104 that defines in one portion a lip 106 and in another portion a projection 108 (FIG. 7). The insert 74 also has an insert or metal pathway 110 formed by a lateral wall 112 and a pair of side walls 114. Located in the lateral wall 112 is a plurality of pathway holes 116. The outer side wall 114 has a first slot 115 and a second slot 117. It is further understood that the metal pathway 110 is preferably formed on both a first, or upper side of the insert 74 and a second, or lower side of the insert 74. As discussed, in one preferred embodiment, the carrier 72 is formed such that a portion of the carrier 72 forms an additional pathway wall 81 (FIG. 7) formed over the edge 104 of the insert 74. In this way the carrier pathway wall 81 helps to further define the insert or metal pathway 110 in cooperation with the lateral wall 112 and the inner side wall 114. As further discussed, the insert 74 could be dimensioned so that the inset side wall 114 forms the complete pathway wall.

The insert 74 is substantially flush with the carrier so that the insert pathway 110 communicates with the first carrier pathway 73 and together they form an overall gasket pathway 118. The pathway 118 may be considered to include the pathways around the insert openings 84,86 included on the upper and lower surfaces of the carrier 72 as well as the additional pathways 73,75 on the plastic carrier 72. As can be appreciated, the first slot 115 and the second slot 117 assist in providing communication between the insert pathway 110 and the carrier pathways 73,75. In other words, the gasket pathway 118 has a first portion or segment 73 defined by the plastic carrier 72 and a second portion or segment formed by the metal insert 74. Accordingly, a portion of the pathway 118 is defined by metal and a portion of the pathway is formed by plastic. Furthermore, as shown in FIG. 7, in a preferred embodiment, a portion of the insert pathway 110 may also be defined by the pathway wall 81 of the plastic carrier 72.

The first bead 78 is received by the overall gasket pathway 118. The bead 78 has a first or upper bead portion 120 located on the upper surface of the carrier 72 and a second or lower bead portion 122 located on the lower surface of the carrier 72. The use of the terms upper and lower have no significance other than to distinguish the two bead portions 120,122 as shown in FIG. 7. The upper bead portion 120 is connected to the lower bead portion 122 wherein a portion of the elastomer extends through each pathway hole 116. The upper bead portion 120 is also connected to the lower bead portion 122 where the portions 120,122 meet where the pathway 118 extends to a peripheral edge of the carrier 72.

Each bead portion 120,122 has a generally M-shaped cross section as seen in FIG. 7. Additionally, the cross section of the beads 120, 122 could be described as having the shape of a flanged T. The cross section of each bead portion 120, 122 is comprised of a bead base 124, a central bead leg 126 and a pair of outer bead legs 128. The central bead leg 126 and outer bead legs 124 each extend from the bead base 124 in the same direction. However, the central bead leg 126 extends further than either of the outer bead legs 128. Additionally, it can be seen that a distance D as shown in FIG. 7 and defined by the central bead leg 126 of the upper bead portion 120 and the central bead leg 126 of the lower bead portion 122 is greater than a thickness t of the interior wall 90 and is also greater than a thickness t′ of the gasket carrier 72. Also, an end or extent 127 of the central bead leg extends beyond a surface 71 of the carrier 72.

Similar to the gasket 10 of the previously described embodiment, the gasket assembly 70 is produced by a process of over-molding to be described in detail below. However, it can be seen primarily in FIG. 7 that a portion of the outer edge 104 of the insert 74 is embedded within the plastic carrier 72. The lip 106 and the projection 108 defined by the edge 104 are also embedded within the plastic carrier 72. It is understood that the gasket 70 can take many different shapes and forms. Additionally, the gasket 70 may be adapted to be placed between any two components to seal mating openings of the components.

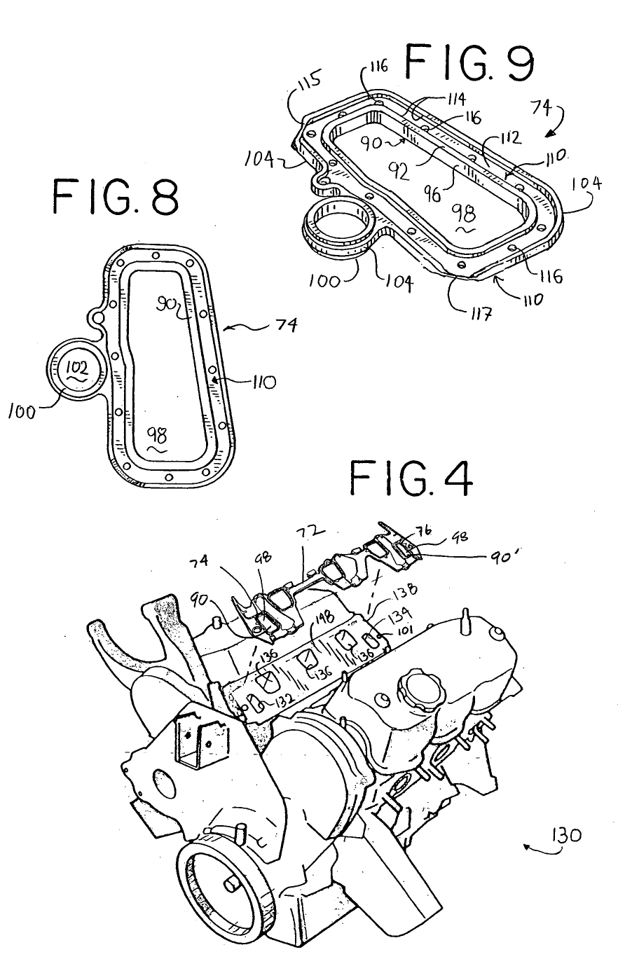

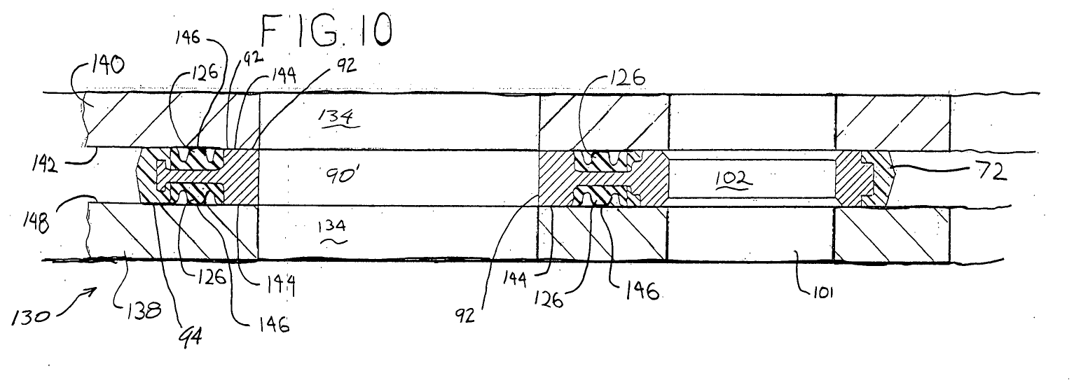

FIGS. 4 and 10 show the gasket assembly 72 in one environment of anticipated use. A schematic of an internal combustion engine assembly 130 is shown. The engine assembly 130 may include a first fluid or coolant passageway 132, a second fluid or coolant passageway 134 and a plurality of other passageways 136. Each passageway 132,134,136 is defined in part by an engine block 138 and a mating engine head 140 (FIG. 10). It can be seen that the gasket assembly 70 is adapted to be disposed or sandwiched between the engine block 138 and the engine head 140. When so sandwiched, the fluid opening 98 of the insert 74 is aligned with the first fluid passageway 132. Similarly, a fluid opening 98 of the mirror image second insert 76 is aligned with the second fluid passageway 134. Therefore, in an assembled state, each coolant passageway is defined in combination by the engine head 140, the interior wall 90 and face 96 of the metal insert 74 and the engine block 138.

Also, the limiter or spacer 100 will be aligned with a fastener bore 101 through the engine assembly 130 for fastening the block 138 to the head 140 via any known fastener. The spacer 100 assures adequate space is maintained between the block 138 and head 140 so that the fastener is not over-torqued, which could damage the carrier 72.

As further shown in FIG. 10, in an assembled state, a head surface 142 of the engine head 140 confronts and contacts the upper surface 92 of the interior wall 90 of the insert 74. The head surface 142 also contacts and compresses the upper bead portion 120. More specifically, at least the central bead leg 126 is sufficiently compressed to form a fluid tight seal, to be further discussed.

The contact between the head surface 142 and the upper surface 92 provides a seal 144 between the fluid opening 90 and the rest of the coolant passageway 132, the quality of which depends upon the smoothness of the two surfaces. The contact between the head surface 142 and the upper bead portion 120 compresses the bead portion 120 and creates a secondary fluid tight seal 146. Given the elastomeric properties of the bead 78, this secondary seal 146 will not allow any coolant or fluid to pass from the fluid opening 90 and past the bead 78.

Similarly, a block surface 148 of the engine block 138 confronts and contacts the lower surface 94 of the interior wall 90 of the insert 74. The block surface 148 also contacts and compresses the lower bead portion 122. More specifically, at least the central bead leg 126 is sufficiently compressed to form a fluid proof seal, to be further discussed.

The contact between the block surface 148 and the lower surface 94 provides a seal 144 between the fluid opening 98 and the rest of the coolant passageway 132, the quality of which depends upon the smoothness of the two surfaces. The contact between the block surface 148 and the lower bead portion 122 creates a secondary fluid tight seal 146. Given the elastomeric properties of the bead 78, this secondary seal 146 will likewise not allow any coolant or fluid to pass from the fluid opening 98 and past the bead 78.

As can be seen, the gasket assembly 70 permits coolant or other fluid to flow through the coolant passageway 132,134 without ever contacting the plastic carrier 72. The coolant is only allowed to contact the metal insert 74 and specifically, the interior face 96 of the interior wall 90 that defines the inlet opening 98. This will generally prevent the coolant from breaking down, or otherwise deteriorating the structural integrity of the plastic carrier 72. The coolant will not break down the metal insert 74. This protects the carrier 72 from the coolant or other fluid and provides a means for shielding the carrier 72 from said fluid. Also, the gasket assembly 10 includes a positive and improved attachment between the insert 74 and the carrier 72, without the use of any adhesive or other fastener.

It should be noted that the plastic base 72 may also include additional beads 81 surrounding the central openings 88. The additional beads 81 will be received by additional pathways 119, similar in structure to previously described pathways, and which may be considered apart of the pathway 118 as previously discussed. The plurality of passageways 136 with which the central openings 88 align may be utilized to carry any fluid or other substance that will not interact with the plastic carrier 72. Of course, any or all of the central openings 88 could be adapted to receive and/or hold an additional metal insert shaped to be received by said openings.

Additionally, the carrier of either of the above describe embodiments may be formed of any suitable plastic. It has been found that a glass filled polymer is a preferred material. The metal inserts may be formed of any suitable metal or other material that will not react with the fluid flowing there through. It has been found that compressed metallic powder is a preferred material for the inserts. A preferred material for the elastomer described above is liquid silicone rubber, although any rubber material, or material with sufficient rubber-like properties will suffice.

FIGS. 11 and 12 schematically disclose a process used to manufacture the gasket assembly 70. First, a pair of metal inserts 74,76 are placed in an injection mold 150. As discussed, it is understood that the metal inserts 74,76 are identical. It is further understood that a gasket 70 could be made using a single insert 74. The second metal insert 76 is placed in the mold in an inverted configuration from the first metal insert 74. The injection mold 150 is adapted to hold the inserts 74,76 and further has a series of hollow spaces configured to form the shape of the plastic carrier 72. A plastic material 152 is injected into the mold 150 through an injection port. The plastic material 152 fills in the hollow spaces of the mold to form a plastic carrier 72. It is understood that the plastic material 152 will flow around a portion of the edge 104 of the inserts 74,76 such that a portion or portions thereof become embedded within the carrier 72. Specifically, portions of the lips 106 and projections 108 become embedded within the carrier 72. This process may be referred to as an over-molding process. It is further understood with reference to FIGS. 7 and 10, that the injection mold 150 is shaped such that plastic material is formed such that the plastic carrier 72 forms the additional pathway walls 81 generally around a periphery of the metal insert 74,76. Thus, in one preferred embodiment, the pathway 110 defined around the opening 98 of the insert 74,76 has the base or lateral wall 112 and vertical inner wall 114 made of metal and the outer vertical wall made of plastic (defined by the plastic pathway wall 81). The interior wall 90 defining the opening 98 of the insert, however, is made completely from the metal material of the insert 74,76. This is the only wall that the fluid will contact.

Once the plastic material 152 has hardened to form the carrier 72, carrier 72 (along with the embedded inserts 74, 76) is removed from the mold. The carrier 72 and inserts 74, 76 are coated with a primer. The primer may be sprayed on the carrier 72 and inserts 74,76 or the entire carrier 72 may be dipped in a solution of the primer. Although use of a primer is not required, the primer enhances the connection of the bead 78 of silicone rubber.

As shown in FIG. 11, the carrier 72 is then placed in a second injection mold 154. The second mold 154 includes a series of hollow spaces that correspond in shape and location with the elastomeric bead(s) 66,78,80. An elastomeric material is injected into the mold at multiple locations through various injection ports. The elastomer flows to fill in the hollow spaces of the mold, and into the various pathways as described above. The elastomer flows to fill in the various pathway holes previously described. This includes formation of the entire elastomer bead 66 formed on the upper and lower surfaces of the gasket 70 and around the various openings of the gasket 70. Once the elastomer cures, the completed gasket assembly is removed from the second injection mold 154. As discussed, in one preferred embodiment, the elastomer is a silicone rubber.

The gasket assembly 10,70 provides significant advantages. As discussed, the metal insert 74 completely defines the opening for the fluid or coolant that passes through the engine components. As the opening is completely defined by the metal material, the coolant only contacts the metal insert material. The insert 74 prevents the coolant from contacting the plastic base or carrier 72. Thus, the coolant will not have an opportunity to degrade the base 72. Furthermore, to achieve such a construction, an entire, expensive metal gasket is not required. The above described hybrid construction of plastic and metal provides a more economical construction.

While the specific embodiments and various details thereof have been illustrated and described, numerous modifications come to mind without significantly departing from the spirit of the invention and the scope of protection is only limited by the following claims.

1. A gasket assembly comprising:
a plastic base; and
a metal insert carried by the plastic base, the metal insert defining an opening spaced away the base, the opening adapted to receive a flowable substance to pass therethrough.

2. The gasket assembly of claim 1 further comprising an elastomer member about a perimeter of the opening.

3. The gasket assembly of claim 2 wherein the member has a flanged-T-shaped cross section having flanged T-shape.

4. The gasket assembly of claim 1 further comprising a spacer carried by the plastic base.

5. The gasket assembly of claim 4 wherein the metal insert and the spacer are formed from a unitary piece of metal.

6. The gasket assembly of claim 4 wherein the spacer is adapted to receive a fastener.

7. The gasket assembly of claim 1 further comprising a second metal insert carried by the plastic base, the second metal insert defining a second opening.

8. The gasket assembly of claim 7 wherein the second metal insert is a mirror image of the metal insert.

9. The gasket assembly of claim 1 further comprising a pathway having a first segment defined by the plastic base and a second segment defined by the metal insert.

10. The gasket assembly of claim 9 wherein the pathway receives a bead of elastomeric material adapted to seal the first passageway to the second passageway.

11. The gasket assembly of claim 9 wherein the first segment is contiguous with the second segment.

12. The gasket assembly of claim 1 wherein the metal insert defines a pathway about a perimeter of the fluid opening.

13. The gasket assembly of claim 12 wherein an elastomer is received in the pathway.

14. The gasket assembly of claim 13 wherein a portion of the pathway is defined by the plastic carrier in cooperation with the metal insert.

15. The gasket assembly of claim 14 wherein the metal insert has an outer edge, wherein the edge defines a protrusion embedded within the plastic base.

16. The gasket assembly of claim 14 wherein the edge defines a lip embedded within the plastic base.

17. The gasket assembly of claim 1 wherein the metal insert has a first side and a second side.

18. The gasket of claim 17 wherein an elastomer member is positioned around the opening on the first side and the second side.

19. The gasket of claim 1 wherein the metal insert has a first passageway on the first side and a second passageway on the second side.

20. The gasket of claim 19 wherein an elastomer member is received in the first passageway and the second passageway.

21. A gasket assembly for use with a first engine component having a first passageway and a second engine component having a second passageway, the gasket assembly comprising:
a plastic base adapted to be disposed between the first engine component and the second engine component and defining an opening adapted to align with the first and second passageways when the base is disposed between the first and second engine components; and
a protector in communication with the opening of the base and adapted to protect the base from a fluid flowing through the first passageway and the second passageway.

22. The gasket assembly of claim 21 further comprising a bead of elastomeric material received by the protector.

23. The gasket assembly of claim 21 wherein the protector is formed from a metal.

24. The gasket assembly of claim 21 wherein the protector further comprises a spacer integral therewith adapted for spacing the first engine component from the second engine component.

25. The gasket assembly of claim 21 further comprising a pathway having a first segment defined by the base and a second segment defined by the protector, the pathway receiving a bead of elastomeric material.

26. The gasket assembly of claim 21 wherein the assembly has a first side and a second side, the first side having a first pathway having a first segment defined by a first side of the base and a second segment defined by a first side of the protector, the first pathway receiving a first bead of elastomeric material, and the second side having a second pathway having a first segment defined by a second side of the base and a second segment defined by a second side of the protector, the beads of elastomeric material adapted to seal the first coolant passageway to the second passageway when the assembly is sandwiched between the first engine component and the second engine component.

27. A gasket assembly for use with a first engine component having a first coolant passageway and a second engine component having a second coolant passageway, the gasket assembly comprising:
a metal insert adapted to be disposed between the first engine component and the second engine component, the insert defining an opening adapted to be aligned with the first coolant passageway and the second coolant passageway, the insert defining a pathway generally around the opening;
a plastic base positioned around the metal insert; and
a bead of elastomeric material received by the pathway.

28. The gasket assembly of claim 27 wherein the insert has a first side and a second side, the pathway defined by the first side of the insert and the second side of the insert defining a second pathway, and further comprising a second bead of elastomeric material receive by the second pathway.

29. The gasket assembly of claim 27 wherein the pathway is defined by a side wall and the side wall defines the opening.

30. The gasket assembly of claim 27 wherein the bead has a cross section that is generally M-shaped.

31. The gasket assembly of claim 27 wherein the bead has a cross section that is generally a flanged T-shaped.

32. The gasket assembly of claim 27 wherein the bead comprises a base, two outer legs and a central leg, each leg extending from the base in the same direction, wherein the central leg extends further than the two outer legs.

33. The gasket assembly of claim 27 wherein the pathway is also defined by the plastic base.

34. The gasket assembly of claim 27 wherein the metal insert has an edge embedded within the plastic base.

35. A gasket assembly for use with a first engine component having a first coolant passage way and a second engine component having a second coolant passageway, the gasket assembly comprising:
a plastic base adapted to be sandwiched between the first engine component and the second engine component, the plastic base defining a coolant opening adapted to align with the first coolant passageway and the second coolant passageway when the base is sandwiched between the first engine component and the second engine component; and
means for shielding the plastic base from a coolant adapted to flow through the coolant opening.

36. A gasket for use with a first engine component having a first passageway and a second engine component having a second passageway, the gasket assembly comprising:
a metal insert adapted to be disposed between the first engine component and the second engine component and defining an opening therein and adapted to align with the first and second passageways when the insert is disposed between the first and second engine components; and
a plastic base positioned proximate the insert, wherein the insert protects the base from a fluid flowing through the first passageway and the second passageway.

37. The gasket of claim 36 wherein the opening is completely defined by the metal insert.

38. The gasket of claim 36 wherein the plastic base is formed completely around the metal insert.

39. The gasket of claim 36 wherein the plastic base is injected molded around the metal insert.

40. The gasket of claim 36 further comprising an elastomer member connected to the gasket generally around the opening.

41. The gasket of claim 36 wherein the gasket has a passageway extending around the opening.

42. The gasket of claim 41 wherein an elastomer member is received in the passageway.

43. The gasket of claim 42 wherein the passageway is defined by metal material and plastic material.

44. The gasket of claim 43 wherein the elastomer member has a central leg extending from the gasket.

45. The gasket of claim 36 wherein the metal insert has a first side and a second side.

46. The gasket of claim 45 wherein an elastomer member is positioned around the opening on the first side and the second side.

47. The gasket of claim 36 wherein the metal insert has a first passageway on the first side and a second passageway on the second side.

48. The gasket of claim 47 wherein an elastomer member is received in the first passageway and the second passageway.

49. A gasket assembly for use with an engine assembly having a block and a head, the gasket assembly comprising:
a plastic carrier having a first insert opening and a second insert opening, the carrier having a first side and a second side, the carrier further defining a plastic pathway on the first side and the second side of the carrier;
a first metal insert positioned in the first insert opening and having a first edge embedded in the plastic carrier, the insert having a first side and a second side, the first metal insert further defining a first metal pathway on the first side and the second side of the first metal insert, the first metal pathway being in communication with the respective plastic pathways;
a second metal insert positioned in the second insert opening and having a second edge embedded in the plastic carrier, the second metal insert having a first side and a second side, the second metal insert further defining a second metal pathway on the first side and the second side of the second metal insert, the second metal pathway being in communication with the respective plastic pathways;
a bead of silicon rubber received by the plastic pathways and the metal pathways and adapted to abut the block and head to seal the first and second openings;
wherein the first opening and second opening are adapted to receive coolant passing through the engine block and head, wherein the coolant contacts the first metal insert and the second metal insert and not the plastic carrier.

50. A method of manufacturing a gasket assembly, the method comprising the steps of:
placing a metal insert defining a fluid opening and having an edge into a first injection mold;
injecting the first injection mold with a plastic material such that a plastic carrier is formed about the metal insert wherein the edge of the metal insert is embedded within the plastic carrier; and
removing the plastic carrier from the first injection mold.

51. The method of claim 50 further comprising the steps of placing the plastic carrier into a second injection mold; and
injecting the second injection mold with an elastomeric material such that a bead of the elastomeric material is placed about a periphery of the fluid opening.

52. The method of claim 51 further comprising the step of applying a primer to the plastic carrier and the metal insert prior to injecting the second injection mold.

53. The method of claim 51 wherein the elastomeric material is a liquid silicon rubber.

54. The method of claim 51 further comprising the step of allowing the elastomeric material to cure.

55. The method of claim 51 further comprising the step of allowing the elastomeric material to cure while still within the second injection mold.
